(19) United States
(12) Patent Application Publication
(10) Pub. No.: US 2025/0348581 A1
(43) Pub. Date: Nov. 13, 2025

(54) INFORMATION PROCESSING DEVICE, CONTROL METHOD OF INFORMATION PROCESSING DEVICE, AND RECORDING MEDIUM

(71) Applicant: CANON KABUSHIKI KAISHA, Tokyo (JP)

(72) Inventor: YUKI ITO, Chiba (JP)

(21) Appl. No.: 19/202,531

(22) Filed: May 8, 2025

(30) Foreign Application Priority Data
May 13, 2024 (JP) 2024-077968

(51) Int. Cl. G06F 21/55

(52) U.S. Cl. CPC G06F 21/554; G06F 2221/034

(57) ABSTRACT

An MFP, which is an information processing device, includes a memory storing instructions and a processor. When executing the instructions, the processor causes the information processing device to specify a feature value from a packet of communication performed by the MFP, estimate a usage environment of the MFP using a learning model with the feature value as input data, and transmit the feature value used for estimating the usage environment and information on the usage environment, which is an estimation result of the estimation of the usage environment, to an external server in the same event.

### BACKGROUND

### Field of the Disclosure

The present disclosure relates to an information processing device, a control method of an information processing device, and a recording medium.

### Description of the Related Art

As a security measure, various security-related functions of an information processing device need to be set appropriately. If an information processing device is used in a single environment, setting values that suit the usage environment can be applied at the time of shipment, allowing the information processing device to be used with appropriate security measures without the need for user configuration. For example, focusing on the usage environment of multifunction peripherals, in the related art, they have been used predominantly in office environments with robust network perimeter defenses, and it was sufficient to set the setting values for office environments as default values at the time of shipment. However, in recent years, the diversification of usage environments has led to an increase in the proportion of new usage patterns in usage environments such as telecommuting and public spaces shared by an unspecified number of people. In a new usage environment, the settings will need to be changed from the default values that are set at the time of shipment for an office environment to suit the usage environment. For example, in an office environment, assuming that perimeter defenses are in place, it is desirable to prioritize convenience and allow connections to the management console via the network, but in public spaces, it is desirable to prohibit such connections because there is no perimeter defense and the risk of attack is high. In this way, since appropriate security settings differ depending on the usage environment, when the usage environment changes, the settings need to be changed. An administrator of an information processing device with specialized security knowledge can recognize that settings need to be changed for each usage environment and take measures such as changing the settings to suit changes in the usage environment before using the device. On the other hand, there are cases where information processing devices are managed by users who do not have specialized security knowledge. In order to provide even users who do not have specialized security knowledge with appropriate security settings suited to their usage environments, the usage environments of information processing devices are estimated. As a method for estimating the usage environment of an information processing device, there is a method for estimating the usage environment from trends in packet information collected from audit logs and the like. As an example of a technique for transmitting an audit log from an information processing device, Japanese Patent Laid-Open No. 2022-131233 discloses a printing device that transmits only an audit log linked to a designated application function to a server.

However, it has not been assumed that the estimation result and the communication trend data will be transmitted from the information processing device to an external server such as a cloud server in the same event. If the estimation result and the communication trend data are transmitted in separate events, for example, when the estimation result and the communication trend data are used in combination on an external server, a linking process will be required on the external server side.

### SUMMARY

Embodiments of the present disclosure transmit the estimation result of the usage environment of an information processing device and the information used for the estimation in a form that can be easily used by an external server.

An information processing device according to an embodiment of the present disclosure includes a memory storing instructions and a processor. When executing the instructions, the processor causes the information processing device to specify a feature value from a packet of communication performed by the information processing device; estimate a usage environment of the information processing device using a learning model with the feature value as input data; and transmit the feature value used for estimating the usage environment and information on the usage environment, which is an estimation result of the estimation of the usage environment, to an external server in the same event.

Further features of various embodiments will become apparent from the following description of exemplary embodiments with reference to the attached drawings.

### BRIEF DESCRIPTION OF THE DRAWINGS

FIG. 1 is a diagram illustrating a configuration of a management system.

FIG. 2 is a diagram illustrating a configuration of a controller unit of an MFP.

FIG. 3 is a diagram illustrating a software configuration of the MFP.

FIG. 4 is a flowchart illustrating a process for generating and storing communication trend data and an estimation result of a usage environment.

FIG. 5 is a flowchart illustrating a process for transmitting communication trend data and an estimation result of a usage environment.

FIG. 6 is a diagram illustrating an example of an audit log.

FIG. 7 is a diagram illustrating an example of communication trend data.

FIG. 8 is a diagram illustrating an example of transmission data.

### DESCRIPTION OF THE EMBODIMENTS

### First Embodiment

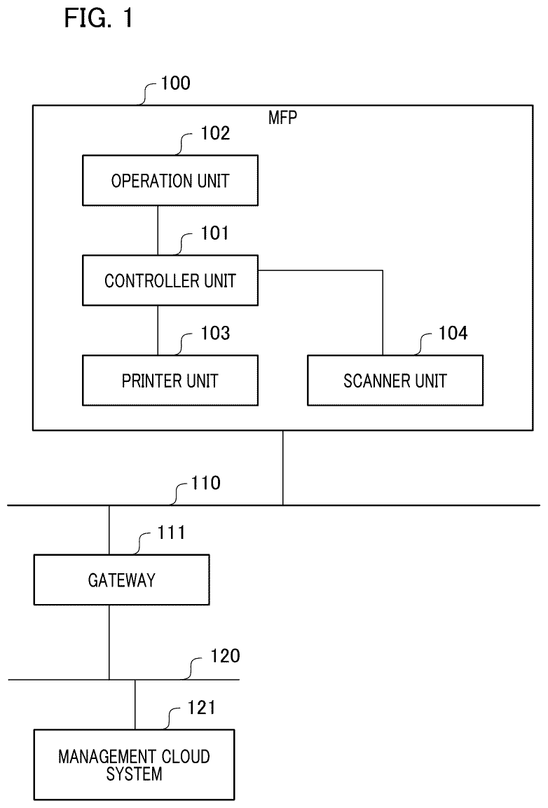

FIG. 1 is a diagram illustrating a configuration of a system that manages an information processing device. The system includes an information processing device to be managed and a management cloud system 121 that communicates with the information processing device via a network. In the present embodiment, a form will be described in which communication trend data (feature values) is created from packets on the information processing device side, the communication trend data is used to estimate the environment in which the information processing device is installed, and then the estimation result and the feature values are notified to the cloud system in the same event.

In the present embodiment, an information processing device to be managed by the management cloud system 121 will be described taking a multi function printer (MFP) 100 as an example. The MFP 100 is an example of an image forming device managed by the management cloud system 121, which is an external server. There may be a plurality of MFPs 100 managed by the management cloud system 121. The MFP 100 is a multifunction peripheral that integrates a plurality of functions such as a printing function and a scanner function. The information processing device to be managed by the management cloud system 121 may be a printer, a scanner device, a 3D printer, and the like, or may be an image processing device such as a camera, or a network device capable of communication such as a smart home appliance.

The MFP 100 includes a controller unit 101, an operation unit 102, a printer unit 103, and a scanner unit 104. The controller unit 101 controls the entire MFP 100. The controller unit 101 also controls communication with external devices, such as the management cloud system 121. The operation unit 102 receives operations from a user or displays information to the user. The operation unit 102 includes, for example, a display unit, such as an LCD panel, that displays the operation status and setting screen (user interface screen) of the MFP 100 and that displays operation keys for setting the operation mode of the MFP 100, copy settings, and the like. The display unit and the buttons may be realized as a touch panel that can be operated by touch using an electrostatic method, a pressure-sensitive method, or the like. By associating input coordinates on a touch panel with display coordinates, it is possible to configure a GUI that makes it appear as if the user can directly operate the screen displayed on the touch panel.

The printer unit 103 outputs electronic data onto a paper medium. For example, the printer unit 103 forms an image according to a received print job and outputs the image onto paper, and the scanner unit 104 outputs an image read onto paper. The scanner unit 104 optically reads a document set on a document tray or an auto document feeder (ADF), which is not illustrated, and converts the read document into electronic data. The operation unit 102, the printer unit 103, and the scanner unit 104 are connected to the controller unit 101 and realize a function as a multifunction peripheral according to the control of the controller unit 101.

The management cloud system 121 provides a service for managing the MFP 100. The management cloud system 121 provides a service for managing a plurality of information processing devices including the MFP 100 by using, for example, a cloud service or a management application. In order to manage the MFP 100, the management cloud system 121 collects information from the MFP 100 and remotely monitors the status of the MFP 100. The management cloud system 121 may be realized by one or more information processing devices, a virtual machine (cloud service) that uses resources provided by a data center that includes information processing devices, or a combination of these.

The MFP 100 and the management cloud system 121 are connected via a network. For example, the MFP 100 and the management cloud system 121 are connected via a LAN 110 and an Internet 120, which are networks, and a gateway 111 that relays the LAN 110 and the Internet 120. The gateway 111 is a network router that relays communication from the MFP 100 to the Internet 120. Note that the network 100 may be configured in any communication system as long as it is capable of transmitting and receiving data. For example, the network 100 may be composed of any one of a LAN, a WAN, a cellular network such as LTE or 5G, a wireless network, a telephone line, a dedicated digital line, and the like, or a combination of these.

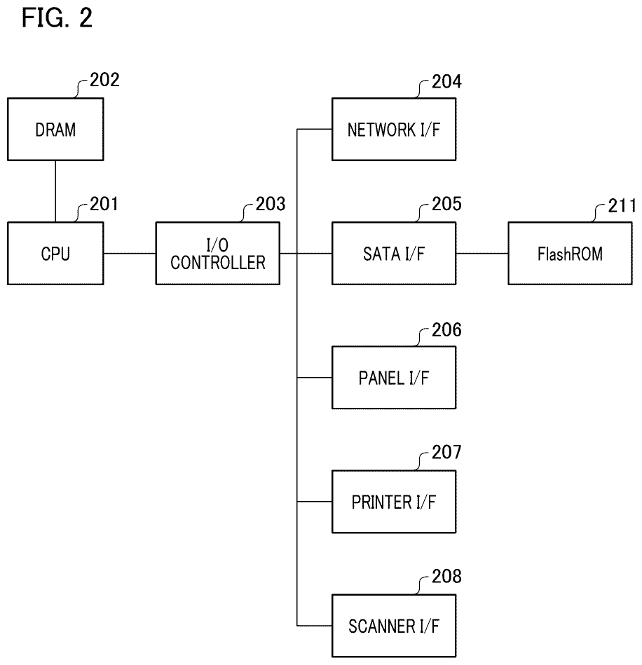

FIG. 2 is a diagram illustrating the configuration of the controller unit 101 of the MFP 100. The controller unit 101 of the MFP 100 includes a central processing unit (CPU) 201, a DRAM 202, an I/O controller 203, a flash ROM 211, and various I/Fs. The various I/Fs include a network I/F 204, a serial advanced technology attachment (SATA) I/F 205, a panel I/F 206, a printer I/F 207, and a scanner I/F 208.

The CPU 201 performs the main arithmetic processing within the controller unit 101. The CPU 201 is connected to the DRAM 202 via a bus. The DRAM 202 is used by the CPU 201 as a working memory for temporarily loading program data indicating arithmetic instructions in the process of arithmetic operations by the CPU 201 and data to be processed. In addition, the CPU 201 is connected to the I/O controller 203 via a bus.

The I/O controller 203 controls input and output to and from various devices, such as the operation unit 102, the printer unit 103, and the scanner unit 104, and external devices, in accordance with instructions from the CPU 201. The I/O controller 203 connects to the flash ROM 211, which is a storage device, via the SATA I/F 205. The flash ROM 211 stores programs for realizing the functions of the MFP 100 and data, such as document files. Examples of data stored in the flash ROM 211 include image data, such as PDF data and JPEG data. In addition, a large-capacity storage device, such as a hard disk drive (HDD) or a solid state drive (SSD), may be connected to the SATA I/F 205 instead of the flash ROM 211.

The network I/F 204, the panel I/F 206, the printer I/F 207, and the scanner I/F 208 are connected to the I/O controller 203. A wired LAN device is connected beyond the network I/F 204. A network, such as the LAN 140, is connected to the network I/F 204. The CPU 201 realizes communication with external devices, such as the management cloud system 121 connected to the LAN 110, via the network I/F 204 and the network. The network I/F 204 may be connected to a wired LAN or a wireless LAN.

The CPU 201 realizes input and output for the user with respect to the operation unit 102 via the panel I/F 206. The CPU 201 realizes a print process using the printer unit 103 via the printer I/F 207. For example, when performing a copy function, the CPU 201 reads program data from the flash ROM 211 into the DRAM 202 via the SATA I/F 205. The CPU 201 detects a copy instruction from the user to the operation unit 102 via the panel I/F 206 in accordance with the program read into the DRAM 202. When the CPU 201 detects a copy instruction, the CPU 201 receives the document as electronic data from the scanner unit 104 via the scanner I/F 208 and stores the read document in the DRAM 202. The CPU 201 performs color conversion processing suitable for output or the like on the image data stored in the DRAM 202. The CPU 201 transfers the image data stored in the DRAM 202 to the printer unit 103 via the printer I/F 207, and performs an output process onto a paper medium. The CPU 201 realizes a scanning process using the scanner unit 104 via the scanner I/F 208.

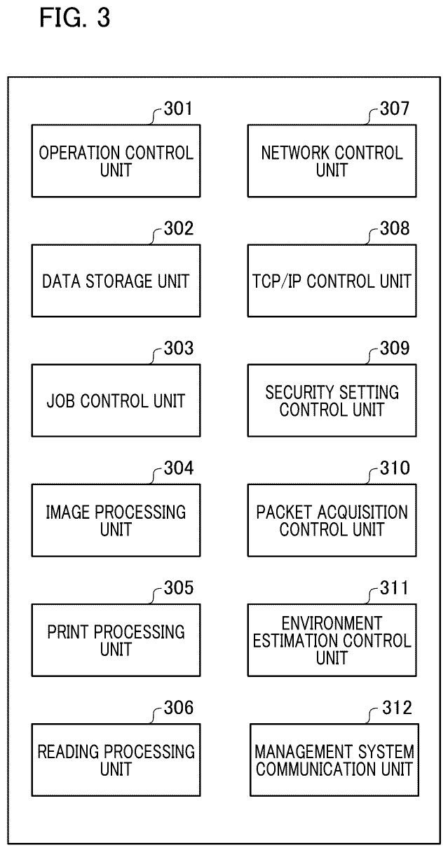

FIG. 3 is a diagram illustrating a software configuration of the MFP 100. The software configuration of the MFP 100 is realized by the CPU 201 of the controller unit 101 reading a program stored in the flash ROM 211 into the DRAM 202 and executing the program. The MFP 100 includes an operation control unit 301, a data storage unit 302, a job control unit 303, an image processing unit 304, a print processing unit 305, a reading processing unit 306, and a network control unit 307. The MFP 100 further includes a transmission control protocol/internet protocol (TCP/IP) control unit 308, a security setting control unit 309, a packet acquisition control unit 310, an environment estimation control unit 311, and a management system communication unit 312.

The operation control unit 301 controls the display and reception of operations on the operation unit 102. Specifically, the operation control unit 301 displays a screen image for the user on the operation unit 102. In addition, the operation control unit 301 detects a user operation and executes a process associated with a screen component such as a button displayed on the screen. The data storage unit 302 stores data by controlling recording to and reading from the flash ROM 211, which is a storage device. For example, when a user changes device settings, the data storage unit 302 stores setting values corresponding to the user's input in the flash ROM 211 based on a request from the operation control unit 301 that detects the content input by the user to the operation unit 102. In the present embodiment, communication trend data (packet feature values) and audit logs are stored in the data storage unit 302. An audit log is a log that stores security-related information when a security-related operation is performed. Audit logs are stored in comma separated values (CSV) format.

The job control unit 303 controls the execution of a job. The image processing unit 304 processes the image data into a format suitable for the intended use in accordance with instructions from the job control unit 303. The print processing unit 305 controls the print process by the printer unit 103. Specifically, the print processing unit 305 prints and outputs an image on a paper medium or the like via the printer I/F 207 in accordance with instructions from the job control unit 303. The reading processing unit 306 controls the scanning process performed by the scanner unit 104. Specifically, the reading processing unit 306 reads the set document via the scanner I/F 208 in accordance with an instruction from the job control unit 303.

The network control unit 307 performs network settings, such as an IP address, on the TCP/IP control unit 308 in accordance with the setting values stored in the data storage unit 302 when the MFP 100 is started up or when a change in settings is detected. The TCP/IP control unit 308 performs transmitting and receiving processes for network packets via the network I/F 204.

The security setting control unit 309 manages the security settings of the MFP 100. As a specific example, the security setting control unit 309 specifies and manages the correspondence relationship between security-related setting values and setting items among the setting values stored in the data storage unit 302, and the correspondence relationship between each setting item and security threats. Furthermore, the security setting control unit 309 manages the correspondence relationship between the usage environment of the MFP 100 and the security setting items corresponding to the usage environment. When the user designates a usage environment, the security setting control unit 309 can set the corresponding security-related settings all at once. The security setting control unit 309 uses the data storage unit 302 to refer to and change security-related setting values.

Here, the usage environment of the MFP 100 will be described. The usage environment is predefined by the vendor into a plurality of types based on the setting environment of the MFP 100, the usage environment of the network to which the MFP 100 is connected, whether or not confidential information is included in the information expected to be used by the MFP 100, and the like. As the usage environment, for example, it is possible to assume a company-intranet environment, an internet-prohibited environment, an internet-direct-connection environment, a public-space environment, a home environment, and an environment that manages highly confidential information. The security settings that should be set in the MFP 100 vary depending on the usage environment. For example, the file sharing function is a function of sharing files over a network within an environment, and in an environment in which unspecified users share the network within the environment, it is desirable to disable the file sharing function in order to prevent information leakage. In other words, it is recommended that a file sharing function be disabled except for a private network environment where specific users share the network within the environment. The private network environments are a company-intranet environment, an internet-prohibited environment, and a home environment. Therefore, except for the above, in an internet-direct-connection environment, a public-space environment, and an environment that manages highly confidential information, it is recommended that the file sharing function be disabled. The above definition of the usage environment does not limit every embodiment of the present disclosure, and some or other usage environments exemplified in the present embodiment may be defined. For example, assuming that the system will be installed within a company, the usage environment may be classified according to industry, such as finance or government agencies. The administrator of the MFP 100 can select one usage environment to be set in the MFP 100 from a selection of usage environments defined by the vendor. In addition, even when a user who does not have specialized security knowledge and cannot determine the usage environment manages the MFP 100, the MFP 100 has a function of estimating the usage environment to support appropriate security settings.

The packet acquisition control unit 310 acquires data (packets, network packet information) transmitted and received by the MFP 100. Network packet information (packets) is collected at the timing when the network control unit 307 starts network communication. The network packet information is made up of information about other information processing devices connected to the same network. The packet acquisition control unit 310 utilizes the network control unit 307 to perform communication in accordance with the corresponding protocol, thereby collecting packets transmitted and received by the MFP 100. The packets (network packet information) to be acquired may be only broadcast or multicast, or may include unicast. The longer the packet acquisition period, the higher the accuracy of the environment estimation, but the longer the period, the longer the resource load time will be. The appropriate packet acquisition period depends on the environment to which the MFP 100 is connected. In an environment with a high packet flow rate, sufficient accuracy can be achieved even if the packet acquisition period is short, but in an environment with a low packet flow rate, sufficient accuracy cannot be achieved unless the packet acquisition period is long. When the acquisition period is set to a short period, for example, 60 seconds, environment estimation is possible. When the collection of the network packet information is completed, the packet acquisition control unit 310 stores the network packet information collected during the current acquisition period in the data storage unit 302. At the timing when the currently acquired network packet information is to be stored, if the network packet information acquired two times previously is stored in the data storage unit 302, this information can be deleted, thereby optimizing the storage area. Therefore, the data storage unit 302 stores the network packet information acquired during the current acquisition period and the network packet information acquired during the previous acquisition period. In the present embodiment, the packet acquisition control unit 310 acquires network packet information during a connection in accordance with an instruction from the environment estimation control unit 311.

The environment estimation control unit 311 collects network packet information during a connection, generates and stores communication trend data, estimates the environment, and stores the estimation results in an audit log. The environment estimation control unit 311 instructs the packet acquisition control unit 310 to collect network packet information during a connection at the timing when the network control unit 307 starts network communication, and the environment estimation control unit 311 causes the packet acquisition control unit 310 to collect packets transmitted and received by the MFP 100. When the collection of packets is completed, the environment estimation control unit 311 specifies feature values from the collected network packet information, generates communication trend data, and stores the data in the data storage unit 302. The communication trend data is data indicating feature values specified from packets transmitted and received by the MFP 100. More specifically, the communication trend data is statistical information indicating feature values generated from collected packets, and the number of received packets by type, such as the source IP address in the IP header of packets acquired during the packet acquisition period, the source port number in the TCP header, and the like. The environment estimation control unit 311 extracts, for example, the source IP address, the IP header information, the port number, the number of receptions, and the like from the information accompanying the packet, and the environment estimation control unit 311 generates communication trend data. Note that when generating the communication trend data, the content portion (payload) of the packets is excluded. The environment estimation control unit 311 stores the generated communication trend data (packet feature values) in the data storage unit 302. In this way, the environment estimation control unit 311 functions as a specification unit that specifies and stores communication trend data (packet feature values).

The environment estimation control unit 311 also estimates the network environment (usage environment) to which the MFP 100 is connected, using a learning model for performing the estimation process of the usage environment. The learning model used by the environment estimation control unit 311 is a trained model that models communication trends (communication trend data, packet feature values) for an already-generated usage environment. The learning model may be disposed in the MFP 100 at the time of shipment, for example, or may be distributed to the MFP 100 from the management cloud system 121. The learning model disposed in the MFP 100 is updated by the management cloud system 121. In estimating the usage environment of the MFP 100 using a learning model, communication trend data (feature value) is used as input data for machine learning, and the estimation result is used as the output of machine learning. The estimation result is information on the usage environment to which the MFP is connected, such as an in-house LAN, a home, or a public space. The environment estimation control unit 311 records and manages the estimation result of the usage environment in an audit log. An audit log is a log that stores when a security-related operation is performed. The audit log can be exported and referred to by the user. The audit log information is stored in the data storage unit 302. In this way, the environment estimation control unit 311 functions as an estimation unit that estimates the usage environment and stores information on the usage environment that is the estimation result in an audit log.

The management system communication unit 312 controls communication between the management cloud system 121 and the MFP 100. The management system communication unit 312 has a function of detecting when a writing is made to the audit log and transmitting the contents written in the audit log to the management cloud system 121. Furthermore, the format of data that the management cloud system 121 can receive is fixed, and the management system communication unit 312 manages the transmission format of data to be transmitted to the management cloud system 121. The format of data that the management cloud system 121 can receive is designated by the management cloud system 121, for example. The management system communication unit 312 uses the network control unit 307 to exchange information with the management cloud system 121. Specifically, the management system communication unit 312 processes the audit log and communication trend data stored in the data storage unit 302 by the environment estimation control unit 311 into transmission data in a format that can be received by the management cloud system 121, and the management system communication unit 312 transmits the transmission data to the management cloud system 121. In this way, the management system communication unit 312 functions as a transmission unit that generates transmission data from the packet feature values (communication trend data) used for the estimation and the estimation results and that transmits the transmission data to the management cloud system 121. The combination of the estimation results of the usage environment collected by the management cloud system 121 from a plurality of MFPs including the MFP 100 and the communication trend data used for the estimation is used to generate a new estimation model or to re-train an existing learning model used by the MFP 100.

In order to use the estimation results of the usage environment and the communication trend data collected from the MFP 100 in the management cloud system 121 for re-training the learning model, etc., the estimation results of the usage environment and the communication trend data used for the estimation should be associated with each other. If the estimation results of the usage environment and the communication trend data are transmitted from the MFP 100 as separate events, they will be stored separately in the management cloud system 121, and processing for linking them in the management cloud system 121 will be required. If the number of devices managed by the management cloud system 121 is large, the search process for linking the estimation results of the usage environment to the communication trend data takes time. Therefore, in the present embodiment, an event is generated in the MFP 100 that combines the estimation results of the usage environment and the communication trend data, so that the estimation results of the usage environment and the communication trend data can be transmitted to the management cloud system 121 in a linked state.

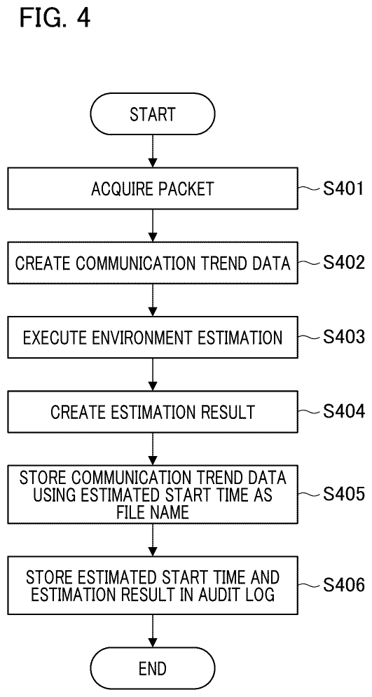

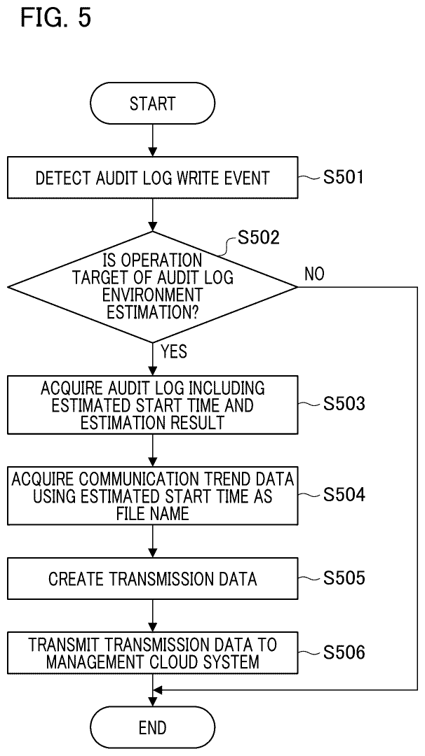

With reference to FIGS. 4 and 5, a process in which the MFP 100 transmits the communication trend data and the estimation result together as one event to the management cloud system 121, which is an external server, will be described. First, a series of processes for acquiring packets, generating communication trend data and an estimation result based on the acquired packets, and storing them in the MFP 100 will be described with reference to FIG. 4. At this time, the communication trend data and the estimation results of the usage environment are stored separately in different data formats, but information linking the communication trend data to the estimation results of the usage environment is recorded in both. In the present embodiment, an example will be described in which communication trend data is linked to the estimation result of the usage environment based on the estimated start time.

FIG. 4 is a flowchart illustrating a process for generating and storing communication trend data and an estimation result. Each process illustrated in FIG. 4 is realized in the MFP 100 by the CPU 201 reading a program stored in the flash ROM 211 into the DRAM 202 and executing the program as arithmetic processing. This process is performed, for example, at the timing when the network control unit 307 of the MFP 100 starts network communication.

In S401, the environment estimation control unit 311 issues an instruction to the packet acquisition control unit 310 to acquire a packet. The packet acquisition control unit 310, which has received an instruction from the environment estimation control unit 311, acquires a packet transmitted and received by the MFP 100. In S402, the environment estimation control unit 311 generates a feature value (communication trend data) from the packet (network packet information) acquired in S401.

In S403, the environment estimation control unit 311 estimates the usage environment of the MFP 100 using a learning model, with the feature value (communication trend data) generated in S402 as input data for machine learning. In S404, the environment estimation control unit 311 generates an estimation result of the usage environment of the MFP 100 as output data of the machine learning in S403. The environment estimation control unit 311 generates information on the usage environment of the MFP 100 as an estimation result of the usage environment using the learning model.

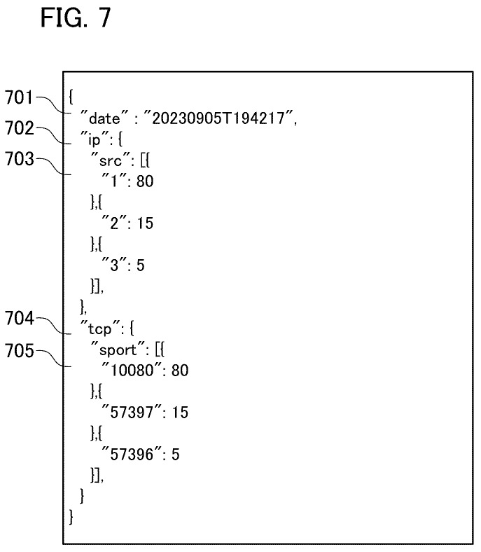

In S405, the environment estimation control unit 311 creates a file of the packet feature values (communication trend data) generated in S402 in JSON format, and the environment estimation control unit 311 stores the file in the data storage unit 302. In the present embodiment, the environment estimation control unit 311 stores the packet feature values (communication trend data) generated in S402 using the estimated start time as a file name as information linking the packet feature values (communication trend data) to the estimation result. An example of the packet feature values (communication trend data) stored in the data storage unit 302 will be described later with reference to FIG. 7. In the present embodiment, an example has been described in which a file of feature values is created and stored after the estimation result of the usage environment is generated in S404. However, the file of feature values may be created and stored (S405) after the usage environment estimation (S403) has started.

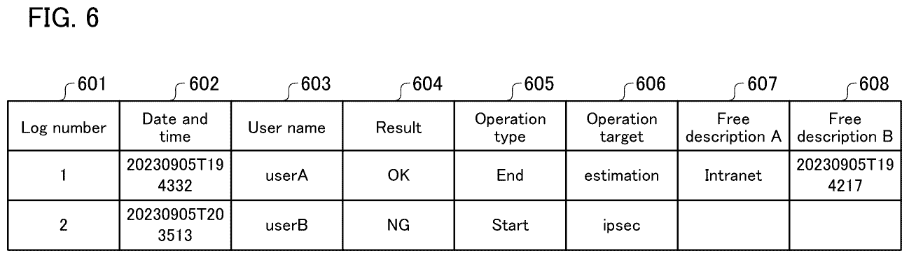

In S406, the environment estimation control unit 311 writes and stores the estimated start time and the estimation result of the usage environment of the MFP 100 generated in S404 in the audit log. The audit log is stored in the data storage unit 302. In addition, the environment estimation control unit 311 writes information related to estimation other than the estimation result in the audit log together with the estimation result of the usage environment. In the present embodiment, the environment estimation control unit 311 writes the estimated start time in the audit log together with the estimation result as information linking the packet feature value (communication trend data) to the estimation result. An example of the estimation result of the usage environment recorded in the audit log will be described later with reference to FIG. 6. Through the above process, the communication trend data and the estimation result of the usage environment can be linked by the estimated start time and stored.

Next, a process in which the management system communication unit 312 of the MFP 100 transmits the estimation result of the usage environment and the communication trend data used for the estimation to the management cloud system 121 in the same event will be described with reference to FIG. 5. FIG. 5 is a flowchart illustrating a process for transmitting an estimation result of a usage environment and communication trend data. Each process illustrated in FIG. 5 is realized in the MFP 100 by the CPU 201 reading a program stored in the flash ROM 211 into the DRAM 202 and executing the program as arithmetic processing. This process is performed when the environment estimation control unit 311 of the MFP 100 stores the estimation result of the usage environment in the audit log. That is, following the process of S406 illustrated in FIG. 4, the process illustrated in FIG. 5 is performed.

In S501, the management system communication unit 312 detects an audit log writing event. The audit log writing event includes an event (S406) in which the estimation result of the usage environment is stored in the audit log. In S502, the management system communication unit 312 determines whether the operation target of the audit log corresponding to the audit log writing event detected in S501 is environment estimation. That is, it is determined whether the contents written in the audit log are the estimation results of the usage environment. When the operation target of the audit log is an estimation of the usage environment, the process of S503 is performed. When the operation target of the audit log is not environment estimation, this flow ends.

In S503, the management system communication unit 312 acquires the audit log corresponding to the audit log writing event detected in S501. Here, the audit log acquired by the management system communication unit 312 is an estimation result of the usage environment. The acquired audit log includes an estimated start time. In S504, the management system communication unit 312 acquires, from the data storage unit 302, communication trend data having the estimated start time acquired in S503 as a file name.

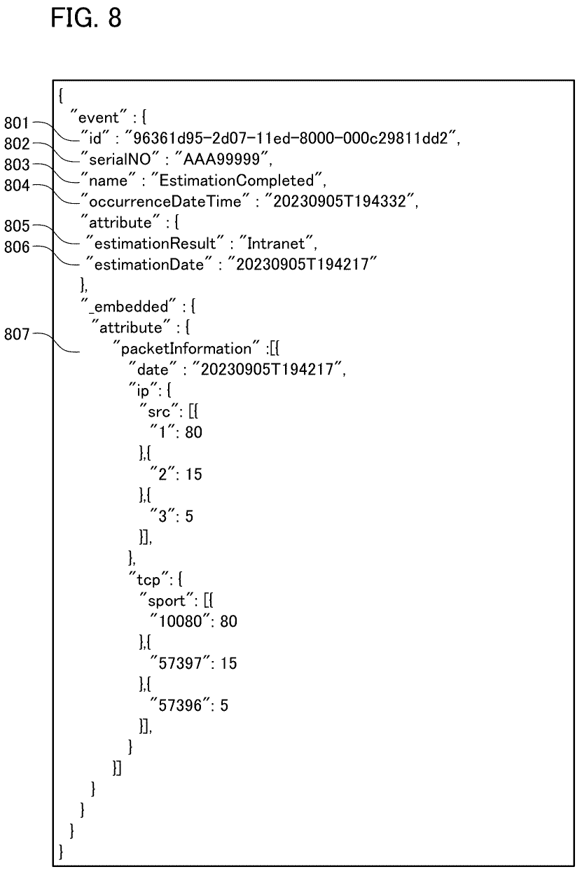

In S505, the management system communication unit 312 generates transmission data in a data format that can be received by the management cloud system 121, from the estimation result of the usage environment acquired in S503 and the communication trend data acquired in S504. The transmission data includes the estimation result of the usage environment and the estimated start time acquired from the audit log and includes the packet feature value (communication trend data) acquired from the data storage unit 302. The transmission data also includes information necessary for transmission. The format of data that the management cloud system 121 can receive is fixed, and the management system communication unit 312 defines the transmission format with the management cloud system 121. The management system communication unit 312 includes information necessary for transmission in the transmission data according to the transmission format designated by the management cloud system 121. As information necessary for transmission, the transmission data includes an event ID as information for uniquely identifying the event, an event name, an event occurrence time, and information for specifying the MFP 100 that is the source of the transmission data. The event occurrence time is, for example, the date and time when the audit log writing event is detected, that is, the date and time when the estimation result of the usage environment is stored in the audit log. In the present embodiment, the serial number of the MFP 100, which is information for uniquely identifying the MFP 100, is included in the transmission data as information for specifying the information processing device that is the source. The management system communication unit 312 generates transmission data in a format that can be received by the management cloud system 121. In the present embodiment, the management system communication unit 312 generates the transmission data in JSON format. The communication trend data created in S405 is in JSON format, and the transmission data created in S505 is also in JSON format. An example of the transmission data will be described later with reference to FIG. 8. In S506, the management system communication unit 312 transmits the transmission data generated in S505 to the management cloud system 121. By the processing in S505 and S506, the MFP 100 can transmit the packet feature values (communication trend data) used to estimate the usage environment and the information on the usage environment that is the estimation result to the management cloud system 121 in the same event.

Through the above process, the communication trend data and the estimation results of the usage environment linked by the estimated start time can be collected into the same event (one piece of transmission data) and transmitted from the MFP 100 to the management cloud system 121. By combining the communication trend data and the estimation results of the usage environment into one piece of transmission data in advance, there is no need for the management cloud system 121 to perform processing to specify the combination of the communication trend data and the estimation results of the usage environment that were transmitted separately.

A specific example of the process will be described using the audit log illustrated in FIG. 6, the communication trend data illustrated in FIG. 7, and the transmission data illustrated in FIG. 8 as examples. FIG. 6 is a diagram illustrating an example of an audit log. The audit log is stored in the data storage unit 302. The audit log includes, for example, a log number 601, a date and time 602, a user name 603, a result 604, an operation type 605, an operation target 606, a free description A 607, and a free description B 608.

The log number 601 is the number of the log. The date and time 602 is the time when the audit log was stored. The user name 603 is the name of the user who performed the operation recorded in the management log. The result 604 indicates whether the operation is OK or not. For example, when the operation is completed normally, OK is stored in the result 604, and when the operation is not completed normally, NG is stored in the result 604. The operation type 605 is the type of operation. In the operation type 605, End, Start, and the like are stored.

The operation target 606 indicates a target of operation. In the case of an audit log of environment estimation, “estimation” is stored in the operation target 606. The free description A 607 and the free description B 608 store different items depending on the operation target. For example, in the case of an audit log of environment estimation, information on the usage environment that is the estimation result of the usage environment is stored in the free description A 607, and the estimated start time is stored in the free description B 608. The estimated start time is, for example, the time when the estimation process was started in S403, expressed as numerical values indicating the year, month, day, hour, minute, and second.

In FIG. 6, log number 1 is an audit log of environment estimation indicating the completion of estimation. Log number 2 is an audit log indicating that IPSec communication has failed. As shown in log number 2, security-related information other than the estimation results of the usage environment is also written to the audit log. The audit log of environment estimation indicated by log number 1 is written to and stored in the audit log in the process of S406 in FIG. 4. In the audit log of the environment estimation indicated by log number 1, the free description A 607 indicating the estimation result of the usage environment is “Intranet” indicating an in-house LAN. In addition, the free description B 608 indicating the estimated start time is 20230905T194217, which indicates 19:42:17 on Sep. 5, 2023. Since the estimation result is written to the audit log immediately after the estimation of the usage environment is completed, the date and time 602 indicating the audit log writing time becomes the estimated end time in the audit log of the environment estimation. Therefore, it is possible to determine whether the estimation process of the usage environment has ended within a specified time based on the time in the free description B 608 indicating the estimated start time and the time in the date and time 602 indicating the estimated end time.

FIG. 7 is a diagram illustrating an example of communication trend data. The communication trend data is in JSON format. The file name of the communication trend data is given with the estimated start time of the usage environment. The communication trend data includes an estimated start time 701, an IP header 702, a source IP address 703, a TCP header 704, and a source port number 705. The estimated start time 701 is the estimated start time of the usage environment, and the estimated start time 701 is the same as the file name. Therefore, to link the estimation result to the communication trend data, the estimated start time 701 may be used instead of the file name of the communication trend data. The estimated start time 701 and the file name of the communication trend data correspond to the estimated start time in the free description B 608 of log number 1 in the audit log illustrated in FIG. 6.

In the present embodiment, the packet feature value (communication trend data) is linked to the estimation result by the estimated start time. The estimated start time is unique information. In addition, since the estimated start time is determined at the time when estimation of the usage environment is started in S403, it is determined before the packet feature value (communication trend data) is stored in S405, and it can be used when storing the packet feature value (communication trend data) in S405. On the other hand, when an attempt is made to link the estimation result to communication trend data using the audit log number, the environment estimation control unit 311 writes in S406 without being aware of the log number and therefore is unable to generate a file (S405) of the packet feature value (communication trend data) using the log number. In addition, the log number has a maximum value, and if the maximum value is exceeded, the log number will loop and will no longer be unique. Therefore, in the present embodiment, the estimated start time is used as information for linking the packet feature value (communication trend data) to the estimation result. In addition, by writing the estimated start time to the audit log, it is possible to compare the estimated end time recorded as the audit log writing time with the estimated start time, making it possible to verify whether the estimation has ended within a specified time. Furthermore, by using the estimated start time as the file name of the packet feature value (communication trend data), it is possible to delete older files based on the file name so that the folder area (memory) does not become full with the packet feature value (communication trend data) files. Furthermore, by including an estimated start time in the transmission data, the management cloud system 121 can ascertain the trend of the time period when analyzing the transmission data. In this way, by recording the estimated start time in both the packet feature value (communication trend data) and the estimation result, it is possible to link the two together and also to use this information to verify whether the estimation has ended within a specified time or to delete old files.

The IP header 702 indicates the IP header. The source IP address 703 indicates the IP address of the source of the packet. Note that the IP addresses are not specific IP addresses, but are indicated by 1, 2, and 3 to indicate the type. In the example illustrated in FIG. 7, 100 packets were acquired during the packet acquisition period, 80 of which had an IP address of 1, 15 of which had an IP address of 2, and 5 of which had an IP address of 3.

TCP header 704 indicates the TCP header. The source port number 705 indicates the port number of the source of the packet. The source port number 705 indicates the type by a specific port number. In the example illustrated in FIG. 7, 100 packets were acquired during the packet acquisition period, 80 of which had a port number of 10080, 15 of which had a port number of 57397, and 5 of which had a port number of 57396. If network packets are used, the communication trend data may be the header portion or the data portion, or the communication trend data may be the packet itself instead of the statistical information.

FIG. 8 is a diagram illustrating an example of transmission data. The transmission data of the estimation result of the usage environment is in JSON format. The transmission data of the estimation result of the usage environment includes an event ID 801, device information 802, an event name 803, an event occurrence time 804, an estimation result 805, an estimated start time 806, and communication trend data 807. The event ID 801 is information for uniquely identifying the current event. The device information 802 is the serial number of the MFP. The event name 803 is the name of the event. In the event of transmitting the estimation result of the usage environment, the event name 803 is “EstimationCompleted.”

The event occurrence time 804 is the time when the transmission data was generated. In the event of transmitting the estimation result of the usage environment, the event occurrence time 804 has the same content as the date and time 602 recorded in the audit log. That is, the event occurrence time 804 is the same as the estimated end time and the audit log writing time. The estimation result 805 is information on the usage environment that is the estimation result of the usage environment. The estimation result 805 has the same content as the free description A 607 recorded in the audit log. The estimated start time 806 is the time when the estimation result of the usage environment started. The estimated start time 806 has the same content as the free description B 608 recorded in the audit log, the file name of the file of packet feature values (communication trend data), and the estimated start time 701 recorded in the file of packet feature values (communication trend data). In the communication trend data 807, the packet feature values (communication trend data) illustrated in FIG. 7 are described.

It is assumed that the packet feature value (communication trend data) illustrated in FIG. 7 is recorded in S405, and the audit log shown in audit log 1 in FIG. 6 is recorded in S406. In this case, in S501, the management system communication unit 312 detects the audit log writing event of log number 1 in FIG. 6. In S502, the management system communication unit 312 acquires an audit log with log number 1 in FIG. 6 that corresponds to the detected audit log writing event, and the management system communication unit 312 determines whether the operation target of the audit log is environment estimation. Since the operation target of audit log 1 is environment estimation, the management system communication unit 312 performs the process of S503. In S503, the management system communication unit 312 acquires an audit log including the estimated start time (free description B 608) and the estimation result (free description A 607) of log number 1 in FIG. 6. In S504, the management system communication unit 312 acquires communication trend data (FIG. 7) having the estimated start time acquired in S503 as a file name. In S505, the management system communication unit 312 generates transmission data (FIG. 8) in JSON format based on the acquired estimation result and communication trend data. The format of data that the management cloud system 121 can receive is fixed, and the management system communication unit 312 defines the transmission format with the management cloud system 121. The communication trend data illustrated in FIG. 7 includes only data related to the environment estimation created by the environment estimation control unit 311 and is not in a format that can be received by the management cloud system 121 as is. Therefore, the management system communication unit 312 creates transmission data in a format that can be received by the management cloud system 121, including the information necessary for transmission as defined in the transmission format with the management cloud system 121, communication trend data, and estimation results. The information necessary for transmission includes, for example, the device information 802 of the MFP 100, the event occurrence time 804, the event name 803, the event ID 801, and the like.

As described above, according to the present embodiment, the MFP 100 can specify feature values (communication trend data) from packets, estimate the usage environment based on the feature values, and transmit the estimation result and the communication trend data together as one piece of transmission data to the management cloud system 121. By transmitting the estimation result and the communication trend data together from the MFP 100 to the management cloud system 121, it becomes unnecessary for the management cloud system 121 to link the audit log to communication trend data information. Therefore, the search process for linking the audit log to communication trend data information in the management cloud system 121 does not take much time, and the processing load in the management cloud system 121 can be reduced. In this way, the information processing device can transmit the estimation result of the usage environment of the information processing device and the information used for the estimation (packet feature value, communication trend data) in a form that can be easily used by the external server.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation to encompass all such modifications and equivalent structures and functions.

This application claims priority to Japanese Patent Application No. 2024-077968, which was filed on May 13, 2025 and which is hereby incorporated by reference herein in its entirety.

What is claimed is:

1. An information processing device comprising:
a memory storing instructions; and
a processor, wherein, when executing the instructions, the processor causes the information processing device to:
specify a feature value from a packet of communication performed by the information processing device;
estimate a usage environment of the information processing device using a learning model with the feature value as input data; and
transmit the feature value used for estimating the usage environment and information on the usage environment, which is an estimation result of the estimation of the usage environment, to an external server in the same event.

2. The information processing device according to claim 1,
wherein the feature value used for estimating the usage environment and the information on the usage environment that is the estimation result are linked using a start time of the estimation of the usage environment, and
wherein, when executing the instructions, the processor creates and transmits transmission data according to a transmission format designated by the external server based on the linked feature value and information on the usage environment that is the estimation result.

3. The information processing device according to claim 2,
wherein the processor records the estimation result of the estimation of the usage environment in an audit log that records information related to security, and
wherein, when executing the instructions, the processor acquires the recorded estimation result from the audit log, and creates the transmission data using the acquired estimation result.

4. The information processing device according to claim 3,
wherein, when the estimation result of the estimation of the usage environment is recorded in the audit log, the start time of the estimation of the usage environment is also recorded.

5. The information processing device according to claim 3,
wherein, in the audit log, information related to security other than the estimation result of the estimation of the usage environment is also recorded.

6. The information processing device according to claim 2,
wherein, when executing the instructions, the processor creates and stores a file of the specified feature value, and
wherein, when executing the instructions, the processor acquires the file of the feature value and creates the transmission data using the acquired file of the feature value.

7. The information processing device according to claim 6,
wherein the start time of the estimation of the usage environment using the feature value is used as a file name of the file of the feature value.

8. The information processing device according to claim 6,
wherein information recorded in the file of the feature value includes the start time of the estimation of the usage environment using the feature value.

9. The information processing device according to claim 6,
wherein the file of the feature value and the transmission data are in JSON format.

10. The information processing device according to claim 1,
wherein, in the external server, the learning model is re-trained using the feature value transmitted from the information processing device and the information on the usage environment that is the estimation result.

11. A control method of an information processing device, the method comprising:
specifying a feature value from a packet of communication performed by the information processing device;
estimating a usage environment of the information processing device using a learning model with the feature value as input data; and
transmitting the feature value used for estimating the usage environment and information on the usage environment, which is an estimation result of the estimation of the usage environment, to an external server in the same event.

12. A non-transitory computer-readable medium storing computer-executable instructions for causing a computer to perform a control method of an information processing device, the control method comprising:
specifying a feature value from a packet of communication performed by the information processing device;
estimating a usage environment of the information processing device using a learning model with the feature value as input data; and
transmitting the feature value used for estimating the usage environment and information on the usage environment, which is an estimation result of the estimation of the usage environment, to an external server in the same event.
